(19) United States
(12) Patent Application Publication
(10) Pub. No.: US 2008/0305266 A1
(43) Pub. Date: Dec. 11, 2008

(54) Sprayable Vehicle Bedliner Compositions And Methods Of Application

(75) Inventors: Zhicheng Li, Solon, OH (US); Thomas J. Staunton, Euclid, OH (US); Weilin Tang, Solon, OH (US)

Correspondence Address: THE SHERWIN-WILLIAMS COMPANY, 101 PROSPECT AVENUE N.W., 1100 MIDLAND BLDG. - LEGAL DEPARTMENT, CLEVELAND, OH, 44115-1075, US

(73) Assignee: THE SHERWIN-WILLIAMS COMPANY, Cleveland, OH (US)

(21) Appl. No.: 12/133,740

(22) Filed: Jun. 5, 2008

Related U.S. Application Data
(60) Provisional application No. 60/942,240, filed on Jun. 6, 2007.

(51) Int. Cl. B05D 1/02; C08L 75/04; B05D 3/12

(52) U.S. Cl. 427/292; 524/590; 525/454; 427/427.5

(57) ABSTRACT

A polyurethane coating composition, sprayable onto a substrate by means of conventional spray equipment at pressures of less than about 100 psi and at temperatures of between ambient to about 50° C., in one or more layers to a film thickness of up to about 30 mils, comprises a resin component having hydroxyl functionality, which may be substantially free of amine functionality, an isocyanate functional curing component, an organotin catalyst, and a catalyst inhibiting amount of a volatile organic acid. The composition may optionally include a fibrous reinforcing material, and a colorant. Advantageously, the coating compositions of the present invention provide polyurethane films having excellent physical properties, solvent and UV resistance, and adhesion to clear coated substrates without the need for adhesion promoting primer coats or chemical pretreatments. The compositions are particular useful to form sprayable vehicle bedliners.

This application claims priority from U.S. Provisional Application 60/942,240 filed Jun. 6, 2007, the entirety of which is incorporated herein by reference.

### I. BACKGROUND OF THE INVENTION

A. Field of Invention

The present invention relates to sprayable polyurethane bedliner compositions and associated methods of application.

B. Background

Sprayable polyurethane and polyurethane/polyurea hybrid truck bedliner compositions have achieved widespread acceptance in place of traditional, preformed plastic bedliner inserts. However, there remains a need to improve sprayable bedliner compositions and associated application processes in order to reduce overall application costs represented by the time and/or equipment expense that is presently required for existing applications, while maintaining desirable physical properties associated with spray applied bedliners, including strong substrate adhesion, high crack and abrasion resistance, and high UV tolerance.

Many existing sprayable bedliner coating compositions must be applied at very high pressures (greater than about 1000 psi) and/or relatively high temperatures because of the fast reactivity between the selected resin and the curing agent that comprise the coating blend. The high reactivity is often caused by the presence of amine moieties in the resin, which are highly reactive with isocyanates. These coating compositions tend to have short useful pot lives of less than about 30 minutes. The high pressure and high temperature spray processes are necessary to ensure that the coating composition can be applied to the vehicle before reaching a detrimental state of cure. The spray apparatuses required for such high pressure spray applications can be prohibitively expensive for prospective users, such as body shops, auto retailers, and auto detailers, that do not have a high volume of demand for bedliner applications. Moreover, the spray guns that are generally used in high pressure applications have very small outlet orifices. This can limit the use of fillers, texturing agents, or other components that can impart desirable physical properties to a polyurethane bedliner, but which can block or clog the outlet orifice and interfere with the application process.

Polyurethane/polyurea hybrid coating compositions that are sprayable at low pressures (less than about 100 psi) have entered the market. However, these products, like their high-pressure sprayable variants, require multiple substrate processing steps to ensure proper adherence of the polyurethane film to the substrate. These processing steps may include the requirement of a primer coat or other chemical pretreatment to improve adhesion between the polyurethane film and the substrate as well as a separate, subsequently applied UV inhibitor coat. These multiple processing steps increase application time and cost and, if performed improperly, may result in a poorly performing bedliner.

The present invention relates to a sprayable polyurethane coating composition, suitable for forming a vehicle bedliner, comprising, in one embodiment, a resin component comprising hydroxyl functionality, desirably by means of a blend of acrylic and polyester polyols, a curing component comprising an isocyanate functional crosslinking agent, which may be an aliphatic isocyanate functional crosslinking agent, such as hexamethylene diisocyanate trimer, an organo tin catalyst, and a catalyst inhibiting amount of a volatile organic acid. The resin component may be substantially free of amine functionality. The coating composition may be blended with a colorant, prior to application. The colorant may be selected to match or contrast with a base coat color on the underlying substrate. Further, the coating composition may include a fibrous reinforcing material, which may improve the bedliner's abrasion resistance and impart a texture to the bedliner.

The coating compositions of the present invention, including those containing fibrous reinforcing materials, may be sprayed onto a substrate, such as the vehicle panels comprising a truck bed, in one or more layers, up to a total thickness of about 20 mils, using conventional spray equipment, such as Shutz type spray guns, operating at pressures of less than about 100 psi within a range of temperatures from ambient to about 50° C. Advantageously, the bedliner coating compositions of the present invention provide polyurethane films having excellent adhesion to clear coated substrates without the need for chemical pretreatment or pre-priming with an adhesive promoter, thus reducing application time and efficiency. Additionally, the compositions of the present invention may permit the spraying of individual layers of relatively high film thickness, thereby reducing the number of layers necessary to achieve a total useful film thickness. The resulting polyurethane film is resistant to abrasion and chipping, is highly solvent resistant, particularly to gasoline and oil, and is highly UV tolerant without the need for additional UV inhibiting topcoats. Further, the compositions have an extensive pot life for longer useful application times facilitating less product waste and preparation time. The coating compositions of the present invention and the associated application processes described herein provide an economical and efficient way to form a vehicle bedliner or other coated panel.

### II. DETAILED DESCRIPTION OF THE INVENTION

According to one embodiment of the present invention, a polyurethane coating composition comprises a resin component and a curing component, in conjunction, optionally, with one or more additives selected from solvents, light inhibitors, catalysts, volatile organic acid catalyst inhibitors, and fibrous reinforcing agents, which, when mixed together comprise a coating blend suitable for spraying onto a substrate, in one or more layers, at pressures of less than about 100 psi to form a polyurethane film having a total thickness of up to about 20 mils. In other embodiments of the invention, the coating blend may further include a colorant and may include a suitable pigment dispersant, to provide a colored or tinted polyurethane bedliner. The resin component of the coating blend may comprise one or a blend of hydroxy-functional polymers (polyols), including hydroxyl-functional polyethers, polyesters, acrylics, polyurethanes, and polycarbonates. Preferably the hydroxyl-functional polymers will have between 2 and 6 hydroxyl groups per molecule, with diols, triols, and tetrols being particularly useful.

Suitable hydroxyl-functional polymers within the classes of molecules defined by the respective polymer backbones (polyether, polyester, acrylic, polyurethane, and polycarbonate), and methods of preparing suitable hydroxyl functional polymers within each class, are well known in the art and are described in considerable detail in U.S. Pat. No. 5,580,926 to Shalati et al., which is incorporated herein by reference for purposes of its teaching of such hydroxyl functional polymers and preparation methods. Both linear and branched polyols are useful in the present invention, however, linear polyols are generally preferred over branched polyols.

Particularly useful polyols for purposes of the present invention include those polymers in the classes of polyester polyols, polyether polyols and acrylic polyols. Polyols having molecular weights in the range of between about 200 and about 10,000 are also generally preferred, though viscosity may be adjusted by use of diluents, thereby permitting the use of higher molecular weight polyols.

In one embodiment, the resin component may comprise an acrylic polyol. A particularly useful acrylic polyol derives from polymerization of monomers comprising styrene, methyl methacrylate, 2-hydroxyethyl methacrylate, butyl acrylate, and methacrylic acid, and having a molecular weight of between about 5000 to about 7000 and a hydroxyl number of about 85.

In a particularly useful embodiment, the resin component may comprise a blend of an acrylic polyol and one or more polyester polyols, particularly polyester diols and/or polyester triols. In a more particularly useful embodiment, the polyester polyols may include polycaprolactone polyols. Suitable polycaprolactone diols include Tone 2221 available from Dow Chemical Co. Suitable polycaprolactone triols include Tone 310, also available from Dow Chemical Co. These polyester polyols are particularly desirable for their relatively low viscosity and molecular weight range.

With reference to the embodiments referenced in the previous paragraph, the resin component may comprise from between about 10 to about 60 weight percent, with respect to total polyol in the resin component, of acrylic polyol, and in another embodiment from about 20 to about 50 weight percent of acrylic polyol, with the remainder, in such embodiments, being substantially polyester polyol or a polyester polyol blend. A useful polyester polyol blend may include from about 50 to about 100 percent of a polyester diol, with the remainder being the polyester triol.

In still another particularly useful embodiment, the resin component may comprise from about 30 to 40 weight percent of an acrylic polyol, from about 50 to about 70 weight percent of a polyester diol, and from 0 to about 20 weight percent of a polyester triol (all weight percents are with respect to the total polyol in the resin component.)

Many existing sprayable polyurethane coating compositions comprise significant amounts of polymers having reactive amine functionalities, which may be present to speed the curing process by means of the relatively rapid formation of urea linkages with isocyanate functional curatives. It is acknowledged that polyamines may be useful active hydrogen-containing compounds in place of all or a portion of the polyols in the resin component, and in a similar manner, polymers having both amine (primary and/or secondary amine) and hydroxyl functionalities may be used, such as isopropanol amine, isobutanol amine, ethanol amine, etc.; however, the presence of amine moieties may have a detrimental effect in increasing the rate of cure and decreasing useful pot life and can increase the susceptibility of the resultant film to UV degradation and yellowing. Thus it is useful in many embodiments that the resin component be substantially free of reactive amine functionality.

The resin component may include an effective amount of a solvent or a solvent blend to adjust the viscosity of the resin component so as to make the resulting polyurethane coating blend sprayable at useful pressures, which are defined, for purposes herein, as pressures of less than about 100 psi, though pressures of less than about 50 psi are also desirable, with pressures of less than about 35 psi also being achievable. Suitable solvents may be selected froms the group of polar organic solvents, and preferably from the group of ethers, esters and ketones. More particularly, solvents may include glycol ethers such as ethylene glycol dimethylether, propylene glycol dimethyl ether; glycol ether esters such as ethyl glycol acetate, butyl glycol acetate, 3-methoxy-n-butyl acetate, butyl diglycol acetate, methoxypropyl acetate; esters such as butyl acetate, isobutyl acetate, amyl acetate; ketones such as methyl ethyl ketone, methyl isobutyl ketone, cyclohexanone, isophorone and aromatic or aliphatic hydrocarbons. For purposes of the present invention, an effective amount of solvent is that amount which is necessary to adjust the viscosity of the polyurethane coating blend to a sufficient level so as to be sprayable at a useful pressure. Though it may be beneficial to include substantially all of the solvent into the resin component, it will be understood that all or a portion of the solvent may be included in the curing component or the colorant, which are described in greater detail below.

The resin component may further include one or more conventional additives which may function as flatting agents, fillers, texturing agents, and/or reinforcing agents. These additives may be of an inorganic or organic nature. Examples of suitable additives include amorphous pyrogenic silica, silica gels and layered silicates, barytes, talc, mica, kaolin, diatomaceous earth, sand, calcium carbonate, barium sulfate, cadmium sulfide, zinc sulfide, organic polymers such as polyester, glass, ceramics, carbon, etc. Such fillers can be used in the form of fibers, spheres, platelets, powders, pellets, etc. Preferred fillers are substantially inert under the conditions encountered when the components of the invention are mixed. Fillers can be used either individually or in admixture. They may, as indicated, be blended into the resin component or, alternatively, into the curing component.

Useful embodiments of the present invention may include an additive blend that includes talc, silica and plastic fibers, particularly polyamide fibers. The talc may act conventionally as a filler. The precipitated silica may act conventionally as a flatting agent. The polyamide fibers may act as a texturing agent. Particularly useful polyamide fibers are 0.01 to about 0.1 inches long. Fibers within this range may be selected to create a texture in the polyurethane film, while not being so large as to clog the spray apparatus. Polyamide fibers sold by E.I. du Pont de Nemours and Company under the trade name Kevlar®, are particularly preferred. Polyamide fibers are believed to provide improved abrasion resistance to the resulting polyurethane film, in addition to texture. In some embodiments, up to about 150 parts (preferably about 50 to 100 parts) by weight filler may be used, based on 100 parts of the polyol component.

Conventional catalysts may optionally be added in conventional amounts, to the resin component (or the curing component) to catalyze the crosslinking reaction in the coating blend. Catalysts that can be used include bismuth-containing catalysts, tertiary amines, such as triethylamine, dimethylethanolamine, triethylene diamine (DABCO), as well as organometallic catalysts such as stannous octate, dibutyltin dilaurate, dibutyltin mercaptide and the like. Organometallic catalysts, such as organotin catalysts are preferred, with dibutyltin dilaurate being particularly useful.

In conjunction with the catalyst, a catalyst complexing or catalyst inhibiting amount of volatile organic acid may be present to act as a catalyst regulator. The presence of this organic acid may temporarily inhibit the catalyst in relation to the reaction of the polyols (or reactive amines, where present) of the resin component and the isocyanates of the curing component. As the acid evaporates, catalyst is increasingly uninhibited. The use of a suitable volatile organic acid may extend the useful pot life of the coating mixture and also may delay vitrification of the coating to facilitate evaporation of solvents from the coating, thereby improving physical and aesthetic properties, namely reducing solvent pop, and permitting application of layers having higher thickness (up to about 10 mils). Useful volatile organic acids may include formic, acetic, propionic, buteric, valerenic, hexanoic, heptanoic, etc, with propionic acid being preferred. A pot-life extending amount of propionic or other organic acid may be used, which amount will depend on the amount of catalyst used. In some embodiments, the amount of volatile organic acid may be from about 1 to about 10 times the amount of active catalyst, and in other embodiments about 2 to about 5 times the amount of active catalyst.

UV light stabilizers, including conventionally used hindered amine light stabilizers (HALS), and benzophenone-type and benzotriazole-type UV light absorbers (UVAs) may also be included in the resin component. Particularly useful are HALS and UVAs sold under the trade name Tinuvin available from Ciba Specialty Chemicals.

A pigment dispersant may optionally be added to the resin component to wet and stabilize the colorants (discussed in further detail below) or fillers. Suitable pigment dispersants include Disperbyk® 161, Disperbyk® 170, Disperbyk® 180, etc, available from BYK-Chemie USA, Inc. Particularly useful pigment dispersants include those described in U.S. patent application Ser. No. 11/756,084 filed May 31, 2007, which is incorporated herein by reference.

Other additives that may be present may include plasticizers, flame-retardants, anti-static agents, fungicides, and bacteriocides.

The polyurethane coating composition further includes, in addition to the resin component, a curing component. The curing component preferably includes polyisocyanates, isocyanate coatings, or mixtures thereof. The isocyanates suitable for use in the preferred embodiments of the present invention may include aliphatic, alicyclic, arylaliphatic, aromatic, and heterocyclic polyisocyanates, or combinations thereof. Any isocyanate or mixture thereof that is suitable for use in the production of polyurethane films and is capable of being sprayed at useful pressures can be utilized in the method of the present invention. Generally, suitable isocyanates include those having the formula Q(NCO)n in which n=2-5 (preferably n=2-4). Referring to this formula, Q may be an aliphatic hydrocarbon group containing 2-18 (preferably 6-10) carbon atoms, an alicyclic hydrocarbon group containing 4-15 (preferably 5-10) carbon atoms, an arylaliphatic group containing 8-15 (preferably 8-13) carbon atoms, and an aromatic hydrocarbon group containing 6-15 (preferably 6-13) carbon atoms.

Examples of suitable isocyanates include ethylene diisocyanate, 1,4-tetramethylene diisocyanate, 1,6-hexamethylene diisocyanate, trimethyl hexamethylene diisocyanate, 1,12-dodecane diisocyanate, cyclobutane-1,3-diisocyanate, cyclohexane-1,3-diisocyanate, cyclohexane-1,4-diisocyanate, diisocyanate-3,3,5-trimethyl-5-isocyanatomethyl cyclohexane, 2,4-toluene diisocyanate, 2,6-toluene diisocyanate, diphenylmethane-2,4′-diisocyanate, diphenylmethane-4,4′-diisocyanate, naphthalene-1,5-diisocyanate, triphenylmethane-4,4′,4″-triisocyanate, isophorone diisocyanate (IPDI), polymethylene polyphenylene polyisocyanates, m- and pisocyanatophenyl sulfonyl isocyanates, perchlorinated aryl polyisocyanates, norbornane diisocyanates, polyisocyanates containing carbodiimide groups, polyisocyanates containing allophanate groups, polyisocyanates containing isocyanurate groups, polyisocyanates containing urethane groups, polyisocyanates containing biuret groups, polyisocyanates produced by telomerization reactions, polyisocyanates containing ester groups, polyisocyanates containing polymeric fatty acid esters, reaction products of the above-mentioned diisocyanates with acetals, and mixtures thereof. Distillation residues (obtained in the commercial production of isocyanates) having isocyanate groups can also be used alone or in solution in one or more of the above-mentioned polyisocyanates.

Particularly useful isocyanates are the aliphatic isocyanates having a % NCO content of about 10% to about 23%, with a particularly preferred aliphatic isocyanates including HDI and IPDI trimers and blends thereof. Aliphatic isocyantates are preferred over aromatic isocyanates for their lower relative toxicity and UV durability. A particularly desirable aliphatic isocyanate is the hexamethylene diisocyanate trimer sold as Tolonate HDT or HDT LV by Rhodia Inc. Mixtures of aliphatic isocyanates and aliphatic and aromatic isocyanates may be used, though in the latter embodiment, it is preferable that the aromatic isocyanates not comprise greater than 25% by weight of the isocyanate portion of the curing component. In other embodiments, the composition may be substantially free of aromatic isocyanates.

While the additives described above have largely been described in connection with their use in the resin component, it will be recognized by one of ordinary skill that all or portions of certain additives may be contained in the curing component. Notwithstanding, many body shops, automotive refinishing facilities and automotive repair shops and dealerships will have access to one or more isocyanate functional curatives due to their widespread use in non-bedliner polyurethane film applications, and access to a source of colorants, which are discussed in further detail below. Therefore, it is particularly desirable that the resin component be packaged in such a manner as to provide associated users with an efficient way to convert existing sources of colorants and isocyanate curatives, such as may be available for use in non bedliner applications, and create with them a bedliner coating composition that is sprayable at relatively low pressures and produces a film that has excellent performance characteristics.

Thus, it is contemplated, in one embodiment, that the resin component will comprise the one or a blend of polyols, the catalyst, the catalyst inhibiting volatile organic acid, the polyamide fibers, the flatting agent, the solvent, the light stabilizers, and optionally, further texturing agents and pigment dispersants, in a single package, which may be, for example, a conventional quart or gallon metal container. By packaging the resin component in this manner, the associated user can use off the shelf colorants and isocyanate curatives to mix a polyurethane coating blend suitable for forming a bedliner to be sprayed, preferably, at low pressure. An exemplary, useful resin component packages may comprise:

(a) a polyol blend, which may be about 20% to about 70%, or, in another embodiment, about 30% to about 46% of total coating solids,

(b) polyamide fibers, which may be about 0.1% to about 5%, or, in another embodiment, about 0.2% to about 2% of total coating solids,

(c) pigment dispersant, which may be from about 0.5% to about 5%, or, in another embodiment, about 1% to about 5% of total coating solids, but may range further depending on the colorant, and is optional depending on whether the use of colorant is anticipated,

(d) a catalyst, which may be about 0.001% to about 0.2%, or, in another embodiment, about 0.005% to about 0.2% of total coating solids,

(e) a catalyst inhibiting organic acid, preferably propionic acid, which may be in an amount of from about 1 to about 10 times, or, another embodiment, about 2 to 5 times the amount of active catalyst,

(f) a light stabilizer, which may be 0.1% to about 5%, or, in another embodiment, about 0.5% to about 3% of total polymer resin solids,

(g) a solvent or solvent blend, which may be about 30% to about 60%, or, in another embodiment, about 40% to about 50% by total weight, and

(h) miscellaneous fillers, including flatting agents, which may include precipitated silica and talc, useful in amounts of 2% to 50%, or 10% to 40% of total coating solids.

While it is contemplated, in one embodiment, that a substantially clear polyurethane film may be formed by mixing the resin component and curing components and then spraying the resulting polyurethane coating composition onto a substrate, it may be desirable to color the coating composition. Thus, it is contemplated in another embodiment that the polyurethane coating composition may comprise, in addition to the resin component and curing components, a colorant. The colorant may be a liquid or powder pigment or dye or primers. Liquid colorants may be achieved, for example, by mixing pigments into a lacquer. Pigments and other colorant sources used in conventional automotive finishing are particularly useful when the polyurethane coating composition is to be used as a bedliner. By using conventional automotive colorants, it is possible to match or augment the color of the bedliner to the base color coat of the associated vehicle to which the bedliner is being applied. In one particularly useful embodiment, toners and blends thereof, such as the tinted P30 primers available from The Sherwin-Williams Co., may be used as a colorant.

To form a bedliner or other coated panel, the resin component, curing component, and, optionally, colorant, may be mixed together to form a substantially homogeneous coating blend. The preferred method of mixing is mixing by hand or by shaker, though any conventional mixing method may be used. A useful blend comprises, by volume, approximately one part of colorant, one part of the curing component, and eight parts of the resin component; however, variation from this ratio may be anticipated. By selecting a substantially amine free resin component and/or including a volatile organic acid with a catalyst, the catalyzed reaction rate between the polyol and the isocyanate may be slowed, allowing useful pot-lives of more than one-half hour, and preferably more than one hour, and more desirably, more than two hours.

To achieve a useful film-forming coating blend, it is generally desirable to use a sufficient amount of the curing component to provide a ratio of total isocyanate groups (—NCO) in the curing component to the hyroxyl groups (—OH) and, if present, other active hydrogen-containing compounds, such as amine groups, in the resin component of at least 1.0/1.0.

The coating compositions of the present invention can be applied to a substrate using a variety of techniques, including brushing, rolling and dipping. However, these coating compositions are particularly well suited for low pressure spray applications. Spraying may optimally be achieved using conventional low pressure spray apparatuses, such as Shutz style or HVLP spray guns in conjunction with properly associated compressors. Of particular importance, some compositions according to the present invention may be sprayable at pressures of less than about 100 psi and other embodiments, less than about 50 psi and still other embodiments, less than about 35 psi. A useful range of pressures is between about 30 and about 100 psi, with 30 to 75 psi being particularly useful and 30 to 50 psi being more particularly useful. The compositions may be sprayed at these pressures at temperatures ranging from ambient temperature to about 50° C.

It is contemplated that the coating compositions of the present invention may be sprayed onto a substrate in one or more layers. A single layer may be sprayed at a thickness of between about 3 and 10 mils without appreciable solvent popping or sag. Solvent popping may be inhibited by the catalyst inhibiting organic acid, allowing individual layers of greater film thickness. Sag may be inhibited by the fiber reinforcing agent. Multiple layers may be sprayed to achieve film thicknesses of at least 20 mils, though total film thicknesses of between about 12 and about 35 mils are generally useful, with a film thickness of between about 15 and about 25, being particularly useful and between about 18 and 23 mils, being still more useful. Advantageously, a second layer of the composition may be sprayed onto a first layer while the first layer is still tacky. Alternatively, subsequent layers may be sprayed onto previously applied layers after the latter have substantially fully cured, though the cured layer should be mildly scuffed, abraded, or otherwise sanded prior to application of the second layer. Layers may have the same or different colors, which may, in some embodiments, allow for the creation of stenciled designs or other multi-color designs. It is anticipated that bedliner application time may be significantly reduced by virtue of the ability to achieve a desired useful total film thickness in fewer layers.

The substrate to be sprayed may be prepared for spraying by simple abrasion or scuffing, such as with a grinder or abrasive paper, to clean the surface and rid the surface of contaminants (e.g. chipping or peeling paint, rust) that might show through the film. It is contemplated, however, that no adhesive primer coat will be necessary to achieve suitable adhesion, though a rust inhibiting layer may be applied. It is also contemplated, in a particularly useful embodiment, that the coating composition will adequately adhere to conventional, manufacturer applied or OEM vehicle topcoats, thus, it is contemplated that new vehicle finishes may be sprayed directly with the coating compositions of the present invention, though it may be useful to scuff, sand, or abrade the surface to improve the adhesion of the resultant film to the substrate.

As indicated, a preferred substrate is a vehicle panel, such as a truck bed. Other metal substrates are also useful, though the coatings described herein may be applied to wood or plastic or cementations substrates.

The following examples further illustrate details of the preparation and use of the compositions of the present invention. The invention is not intended to be limited by these specific examples, however. All parts and percentages are by weight unless otherwise specified.

### EXAMPLE

TABLE 1
Composition

| | Volume | | | | |
|---|---|---|---|---|---|
| Component | Ratio | Chemistry | Functions | Weight | Sub Total |
| I | 1 | tinted primer | colorant | 16.00 | 16 |
| II | 8 | acrylic resin | resin | 18.36 | |
| | | polyester triol | resin | 05.17 | |
| | | polyester diol | resin | 11.67 | |
| | | pigment dispersant | pigment wetting | 01.94 | |
| | | solvent mixture | diluent | 37.20 | |
| | | talc pigment (filler) | filler | 16.14 | |
| | | polyamide | texturing agent | 00.58 | |
| | | precipitated silica | flatting agent | 08.06 | |
| | | HALS | UV stabilizers | 00.65 | |
| | | dibutyltin dilaurate | catalyst | 00.04 | |
| | | propionic acid | catalyst inhibitor | 00.19 | 100.00 |
| III | 1 | HDI | crosslinking agent | 12.50 | 12.5 |

A coating composition according to the present invention may be prepared as shown in Table 1 with a colorant (Component I), a resin component (Component II) and a curing component (Component III). The resin component (Component II) may be prepared by blending all of the ingredients in a high speed disperser for 60 minutes at 5000 rpm. All three components may then be added into a metal can and mixed by a shaker mixer for 10 minutes.

It is believed that the coatings formed from the compositions described herein, show excellent resistance to solvents, such as oil and gasoline, as compared to existing polyurethane bedliner coatings. Further, the coatings have UV resistance that is favorably comparable to that found in manufacturer of OEM topcoats, without the need for a separate UV topcoat. Additionally, the coatings have excellent physical characteristics, including adhesion to manufacturer applied or OEM topcoats (clearcoats), and reduced solvent pop. Importantly, substrates can be sprayed with the compositions of the present invention in individual layers of up to 10 mils thickness apiece, without appreciable solvent pop or sag, thus reducing application time. The embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

We claim:

1. A polyurethane coating mixture comprising:
a resin component, the resin component comprising:
a polyol,
a solvent,
an organotin catalyst,
a volatile organic acid, selected from the group consisting of acetic acid, propionic acid, buteric acid, valerenic acid, hexanoic acid, and heptanoic acid, and a fibrous reinforcing agent, and
a curing agent comprising an aliphatic isocyanate.

2. The composition of claim 1, wherein the polyol comprises an acrylic polyol.

3. The composition of claim 2, wherein the resin component is substantially free of functional amine moieties.

4. The composition of claim 2, wherein the polyol further comprises a polyester polyol.

5. The composition of claim 4, wherein the polyester polyol comprises a blend of a polycaprolactone diol having a molecular weight of between about 500 and 5000, and a polycaprolactone triol having a molecular weight of between about 300 and 2000.

6. The composition of claim 1, wherein the curing component comprises HDI trimer.

7. The composition of claim 6, wherein the curing component comprises a blend of HDI trimer and IPDI trimer.

8. The composition of claim 6, wherein the curing component comprises less than about 25% of aromatic isocyanate.

9. The composition of claim 8, wherein the curing component is substantially free of aromatic isocyanate.

10. The composition of claim 1, wherein the fiber reinforcing additive comprises polyamide fibers having a length of between about 0.01 and about 0.1 inches.

11. The composition of claim 1, further comprising
a colorant, and
a pigment dispersant.

12. A method of forming a coated substrate comprising the steps of:
providing a substrate, and
spraying onto a surface of the substrate by means of a spraying apparatus and at a pressure of between about 30 and about 50 psi, a first layer of a curable polyurethane coating composition comprising a mixture of
a substantially amine free polyol resin component
a curing component comprising HDI trimer,
a polyamide fiber reinforcing agent,
an organotin catalyst, and
a catalyst inhibiting volatile organic acid.

13. The method of claim 11, wherein, prior to spraying the curable coating composition onto the surface of the substrate, the process comprises the step of abrading the surface of the substrate.

14. The method of claim 13, wherein the first layer has a dry film thickness of between about 3 and about 10 mils.

15. The method of claim 14, wherein the first layer has a dry film thickness of between about 8 and about 10 mils.

16. The method of claim 14 further comprising the step of spraying a second layer of the curable polyurethane coating onto at least a portion of the first layer.

17. The method of claim 14, further comprising the step of spraying one or more additional layers of the curable polyurethane coating onto the substrate to obtain a total polyurethane film having a thickness of between about 20 and about 30 mils.

18. The method of claim 12, wherein the substrate is a metal substrate.

19. A coating comprising the blend of:
a colorant;
a resin component, the resin component being substantially free of reactive amine functionality and comprising:
a polyol blend comprising an acrylic polyol and a polyester polyol,
a solvent,
an organotin catalyst,
propionic acid,
a UV light stabilizer, and
a fibrous reinforcing agent, and
a curing agent comprising an aliphatic isocyanate.

20. The coating of claim 19, wherein the polyol blend comprises polyols selected from the group consisting of acrylic polyols and polyester polyols, and blends thereof.
